(19) United States
(12) Patent Application Publication
(10) Pub. No.: US 2003/0130910 A1
(43) Pub. Date: Jul. 10, 2003

(54) Shopping cart presentation

(76) Inventors: Clifford A. Pickover, Yorktown Heights, NY (US); Stephen J. Boies, Mahopac, NY (US); William Grey, Millwood, NY (US); Paul A. Moskowitz, Yorktown Heights, NY (US)

Correspondence Address: BUCKLEY, MASCHOFF, TALWALKAR, & ALLISON, 5 ELM STREET, NEW CANAAN, CT, 06840, US

(21) Appl. No.: 10/041,277

(22) Filed: Jan. 7, 2002

(51) Int. Cl. G06F 17/60

(52) U.S. Cl. 705/27

(57) ABSTRACT

A system includes presentation of an electronic shopping cart to a consumer, and presentation of a representation of an item associated with the electronic shopping cart, wherein the representation is a first representation if the item does not possess a particular characteristic, and wherein the representation is a second representation if the item possesses the particular characteristic.

### CROSS-REFERENCE TO RELATED APPLICATIONS

This application is related to the following co-pending and commonly assigned U.S. Patent Applications (the content of each of which is hereby incorporated by reference herein for all purposes):

U.S. Patent Application Serial No. ______, filed ______ (on even date herewith) for “SYSTEM TO FACILITATE ELECTRONIC SHOPPING” (Attorney Docket No. I01.045 and Client Docket No. YOR920010378US1);

U.S. Patent Application Serial No. ______, filed ______ (on even date herewith) for “OPTIMIZED SHOPPING CART” (Attorney Docket No. I01.046 and Client Docket No. YOR920010377US1);

U.S. Patent Application Serial No. ______, filed ______ (on even date herewith) for “FILTERED SHOPPING CART” (Attorney Docket No. I01.047 and Client Docket No. YOR920010372US1);

U.S. Patent Application Serial No. ______, filed ______ (on even date herewith) for “AUTOMATIC ADDITION TO ELECTRONIC SHOPPING CARTS” (Attorney Docket No. I01.075 and Client Docket No. YOR920010296US1); and

U.S. Patent Application Serial No. ______, filed ______ (on even date herewith) for “SEGMENTED SHOPPING CART” (Attorney Docket No. I01.076 and Client Docket No. Y0920010297US1).

### BACKGROUND OF THE INVENTION

1. Field of the Invention

The present invention relates to electronic shopping. Specifically, the present invention concerns electronic shopping systems utilizing electronic shopping carts.

2. Description of the Related Art

Online stores are fast becoming ubiquitous. A particular online store is often an electronic version of a corresponding brick-and-mortar store. For example, the website located at http://www.CircuitCity.com provides an online store that sells items similar to those sold by conventional Circuit City stores. Some merchants, such as Amazon.com, provide online stores for which no brick-and-mortar counterparts exist.

In a typical online store, a consumer browses Web pages provided by a website. The website is operated by a merchant or by an entity that the merchant has employed for this purpose, and the Web pages present descriptions, pictures and prices of items for sale. The Web pages are organized hierarchically according to item type, and are browsed by selecting hyperlinks included therein. Once a consumer identifies an item for purchase, the consumer inputs a command to add the item to his “shopping cart”. This shopping cart is roughly an electronic counterpart to a conventional shopping cart, in that a consumer associates items with the electronic shopping cart and proceeds to “checkout”, where the items associated with the electronic shopping cart are purchased. Once a particular item is associated with an electronic shopping cart, it must be disassociated with the cart in order to purchase other items in the cart without also purchasing the particular item.

Accordingly, a conventional electronic shopping cart functions quite similarly to a conventional physical shopping cart. However, in order to increase the attractiveness of online shopping, what is needed is an electronic shopping cart providing consumers and merchants with advantageous functionality and features in addition to those provided by conventional shopping carts.

### SUMMARY OF THE INVENTION

In order to address the foregoing, the present invention provides a method, an apparatus, a system, a medium, and means to present an electronic shopping cart to a consumer, and to present a representation of an item associated with the electronic shopping cart, wherein the representation is a first representation if the item does not possess a particular characteristic, and wherein the representation is a second representation if the item possesses the particular characteristic.

By virtue of the foregoing aspect, embodiments of the invention allow a consumer to efficiently determine characteristics of a particular item associated with an electronic shopping cart. With these and other advantages and features that will become hereafter apparent, a more complete understanding of the nature of the invention can be obtained by referring to the following detailed description and to the drawings appended hereto.

### BRIEF DESCRIPTION OF THE DRAWINGS

FIG. 1 is a flow diagram of process steps to provide an electronic shopping cart according to embodiments of the present invention.

FIG. 2 is a topographic view of a network architecture according to embodiments of the present invention.

FIG. 3 is a block diagram of an internal architecture of a store server according to embodiments to the present invention.

FIG. 4 is a block diagram of an internal architecture of a consumer device according to embodiments to the present invention.

FIG. 5 is a representative view of a tabular portion of an item database according to embodiments of the present invention.

FIG. 6 is a representative view of a characteristics database according to embodiments of the present invention.

FIGS. 7A and 7B comprise a flow diagram of process steps to present an electronic shopping cart according to embodiments of the present invention.

FIG. 8 is a representative view of a display presenting data according to embodiments of the present invention.

FIG. 9 is a representative view of a display presenting data according to embodiments of the present invention.

FIG. 10 is a representative view of a display presenting data according to embodiments of the present invention.

FIG. 11 is a representative view of a display presenting data according to embodiments of the present invention.

### DETAILED DESCRIPTION

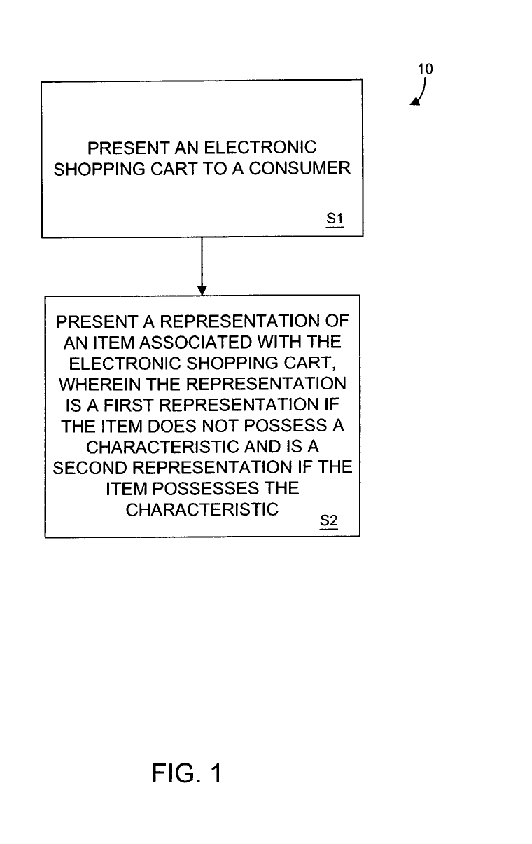

FIG. 1 is a flow diagram of process steps 10 to provide an electronic shopping cart according to some embodiments of the present invention. In order to provide an immediate introduction to features of the present invention, process steps 10 will be generally described with reference to one particular embodiment. Of course, complete descriptions of other specific hardware and software embodiments of the claimed invention are set forth below.

In the particular embodiment, a consumer operates a Web browser so as to access Web pages provided by an online store. During such access, the online store associates an electronic shopping cart with the consumer. The consumer navigates the Web pages to select items to associate with the electronic shopping cart. After several items are selected, the consumer issues a request to view the electronic shopping cart and, in response, the online store creates a Web page presenting the electronic shopping cart.

The Web page is transmitted to the consumer in step S1, thereby presenting the electronic shopping cart to the consumer. The Web page also presents representations of each item associated with the electronic shopping cart. At least one of the representations indicates a particular characteristic of the item. According to step S2, the representation is a first representation if the item does not possess the particular characteristic and is a second representation if the item possesses the particular characteristic. Therefore, transmission of the Web page to the consumer comprises both of steps S1 and S2. In this regard, display of the Web page by a device operated by the consumer may also be considered a performance of steps S1 and S2.

Specific types of first and second representations will be described below, along with specific characteristics that may be indicated by the representations. By virtue of process steps 10, a consumer may easily identify characteristics of items associated with an electronic shopping cart. Consumer satisfaction with the shopping experience may therefore increase, and increased sales may result.

Network Architecture

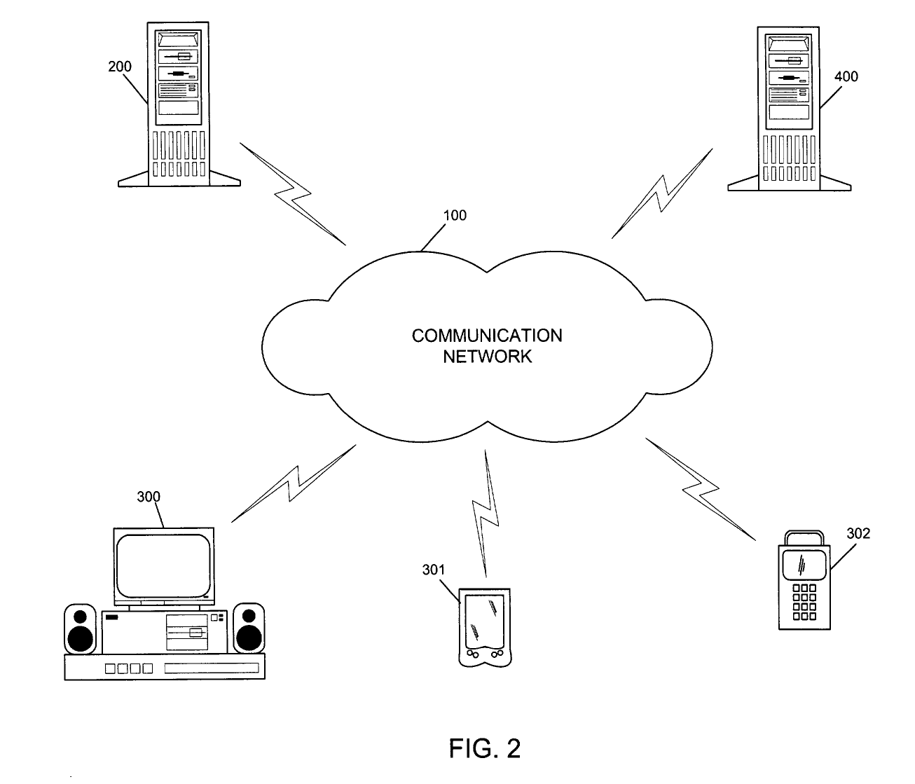

FIG. 2 is a topographic view of a network architecture according to embodiments of the present invention. Of course, network architectures other that that shown in FIG. 2 may be used to implement the invention.

FIG. 2 shows communication network 100 in communication with store server 200, consumer devices 300 to 302 and association server 400. Communication network 100 may comprise any number of systems for transferring data, including a local area network, a wide area network, a telephone network, a cellular network, a fiber-optic network, a satellite network, an infra-red network, a radio frequency network, and any other type of network which may be used to transmit information between devices. Additionally, communication network 100 may be used to transmit data using any known transmission protocol, such as Asynchronous Transfer Mode (ATM), Internet Protocol (IP), Hypertext Transfer Protocol (HTTP) and Wireless Application Protocol (WAP). In one embodiment, communication network 100 is the World Wide Web.

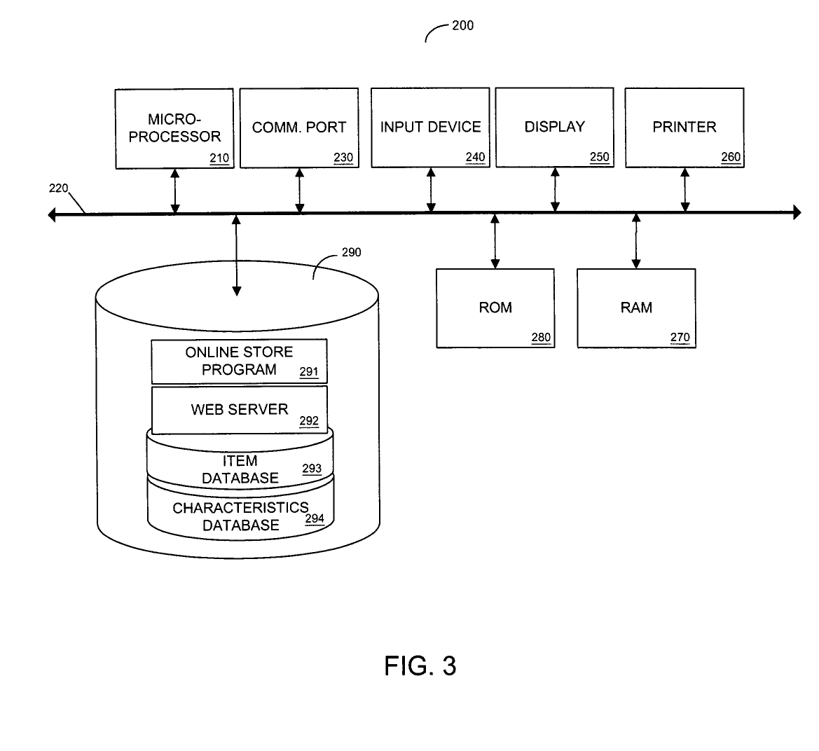

Store server 200 may comprise a Web server, local area network server or other device capable of performing steps according to the present invention. According to some embodiments, store server 200 operates to present an electronic shopping cart to a consumer and to present a representation of an item associated with the electronic shopping cart, wherein the representation wherein the representation is a first representation if the item does not possess a particular characteristic, and wherein the representation is a second representation if the item possesses the particular characteristic. Store server 200 may also control various operations of an entity providing an online store, such as billing, accounting, sales tracking and the like. It should be noted that store server 200 may also perform functions unrelated to an online store. Details of one embodiment of store server 200 are set forth below with respect to FIG. 3.

Consumer devices 300 to 302 of FIG. 2 comprise a desktop computer, a personal digital assistant (PDA) and a cellular telephone. Any one of consumer devices 300 to 302 may be used by a consumer to present an electronic shopping cart to a consumer and to present a representation of an item associated with the electronic shopping cart, wherein the representation is a first representation if the item does not possess a particular characteristic, and wherein the representation is a second representation if the item possesses the particular characteristic. Accordingly, a consumer device according to the invention may comprise any device or devices for transmitting electronic data over communication network 100. Of course, consumer devices 300 to 302 may also be used by a consumer for other functions, such as word processing, scheduling, e-mail, telephone communication, or the like.

Association server 400 may provide information based on which store server 200 associates an item not chosen by a consumer with an electronic shopping cart. Association server 400 may also provide representations of item to store server 200. For a particular item, association server 400 may provide a first representation indicating that the item does not possess a particular characteristic and a second representation indicating that the item possesses the particular characteristic. In some embodiments, association server 400 may include processor-executable process steps to create first and second representations indicating whether or not an item possesses a particular characteristic. Such steps may include steps to apply particular effects to a graphic image, such as resizing, blinking, gray-out, conversion to grayscale, conversion to line drawing, etc. Of course, the foregoing information may be stored on server 200 as well.

It should be noted that the elements of FIG. 2 may be connected differently than as shown. For example, some or all of the elements may be connected directly to one another. Of course, embodiments of the invention may include elements that are different from those shown. Moreover, although the illustrated communication links between the components of FIG. 2 appear dedicated, it should be noted that each of the links may be shared by other components. Additionally, elements shown in communication with each other need not be constantly exchanging data. Rather, communication may be established when necessary and severed at other times or always available but rarely used to transmit data.

Store Server

FIG. 3 is a block diagram of the internal architecture of store server 200 according to one embodiment of the invention. As illustrated, store server 200 includes microprocessor 210 in communication with communication bus 220. Microprocessor 210 may be a Pentium™, RISC™, or other type of processor and is used to execute processor-executable process steps so as to control the components of store server 200 to provide functionality according to embodiments of the present invention.

Also in communication with communication bus 220 is communication port 230. Communication port 230 is used to transmit data to and to receive data from devices external to store server 200. Communication port 230 is therefore preferably configured with hardware suitable to physically interface with desired external devices and/or network connections. In one embodiment, requests to view electronic shopping carts are received from and representations indicating that items were not chosen by consumers to be associated with the electronic shopping carts are presented to consumers over communication port 230.

Input device 240, display 250 and printer 260 are also in communication with communication bus 220. Any known input device may be used as input device 240, including a keyboard, mouse, touch pad, voice-recognition system, or any combination of these devices. Input device 240 may be used by an entity operating store server 200 to input item information, consumer information, billing information, and other information to store server 200. Of course, such information may also be input to store server 200 via communication port 230. Commands for controlling operation of store server 200 may also be input using input device 240.

Display 250 may be an integral or separate CRT display, a flat-panel display or the like. Display 250 is generally used to output graphics and text to an operator in response to commands issued by microprocessor 210. Printer 260 may also output graphics and text, but in hardcopy form using ink-jet, thermal, dot-matrix, laser, or other printing technologies.

RAM 270 is connected to communication bus 220 to provide microprocessor 210 with fast data storage and retrieval. In this regard, processor-executable process steps being executed by microprocessor 210 are typically stored temporarily in RAM 270 and executed therefrom by microprocessor 210. ROM 280, in contrast, provides storage from which data can be retrieved but to which data cannot be stored. Accordingly, ROM 280 is used to store invariant process steps and other data, such as basic input/output instructions and data used during system boot-up or to control communication port 230. It should be noted that one or both of RAM 270 and ROM 280 may communicate directly with microprocessor 210 instead of over communication bus 220.

Data storage device 290 stores, among other data, online store program 291 of processor-executable process steps. Microprocessor 210 executes process steps of online store program 291 in order to control store server 200 to operate an online store. For example, the process steps are executed to present an electronic shopping cart to a consumer, and to present a representation of an item associated with the electronic shopping cart, wherein the representation is a first representation if the item does not possess a particular characteristic, and wherein the representation is a second representation if the item possesses the particular characteristic.

The process steps of online store program 291 may be read from a computer-readable medium, such as a floppy disk, a CD-ROM, a DVD-ROM, a Zip™ disk, a magnetic tape, or a signal encoding the process steps, and then stored in data storage device 290 in a compressed, uncompiled and/or encrypted format. In alternative embodiments, hard-wired circuitry may be used in place of, or in combination with, processor-executable process steps for implementation of the processes of the present invention. Thus, embodiments of the present invention are not limited to any specific combination of hardware and software.

Process steps of Web server 292 are also stored in data storage device 290 and may be executed to provide a website to a Web client, such as a Web browser executing in consumer device 300. In order to provide a website, Hypertext Transfer Protocol (HTTP) requests are received from a Web client and, in response, appropriate Web pages are created and sent to the Web client. In the example of FIG. 3, the Web pages may be created by one or both of online store program 291 and Web browser 292.

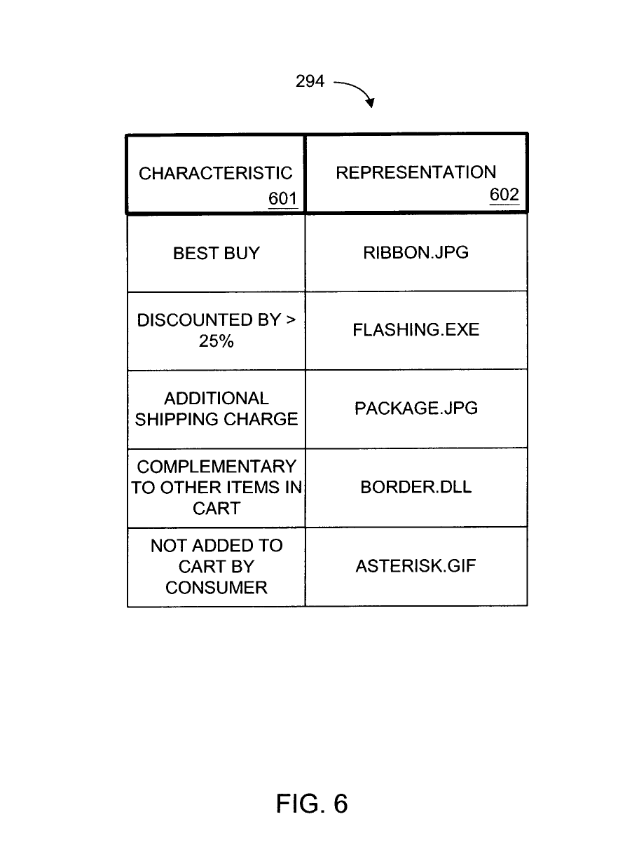

Data storage device 290 also stores item database 293 and characteristics database 294. Item database 293 stores information regarding items for sale. Such information may include a description, a price, and item characteristics. According to embodiments of the invention, the characteristics may be indicated by representations presented to a consumer. One example of item database 293 is described below with respect to FIG. 6.

Characteristics database 294 provides information for generating representations of items that are indicative of item characteristics. The information may include executable files for transforming an image, image files, or any other files usable to generate a representation indicating that an item possesses or does not possess a particular characteristic.

Stored in data storage device 290 may also be other unshown elements that may be necessary for operation of store server 200, such as other applications, other data files, a network server, an operating system, a database management system and “device drivers” for allowing microprocessor 210 to interface with devices in communication with communication port 230. These elements are known to those skilled in the art, and are therefore not described in detail herein.

Consumer Device

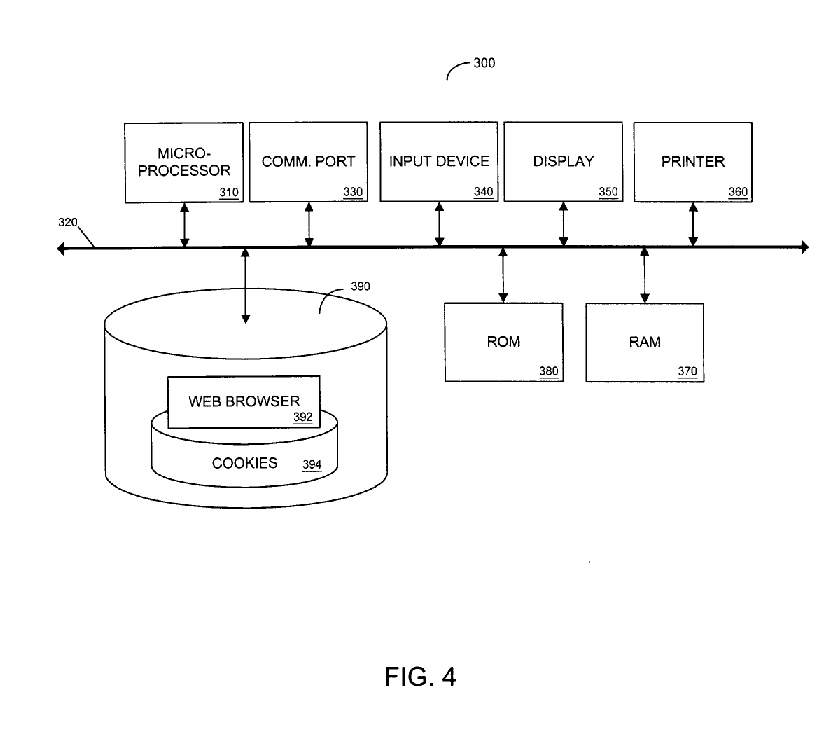

FIG. 4 illustrates several components of consumer device 300 according to embodiments of the invention. The components may comprise any of the specific examples set forth above with respect to identically-named components of store server 200. Of course, specific functions performed by the components may differ from the functions performed by the identically-named components.

In this regard, communication port 330 may be used to transmit requests for information such as Web pages and to receive the information from store server 200. Input device 340 may be used to browse received Web pages and to issue instructions to associate items with an electronic shopping cart, and printer 360 may be used to print out a purchase receipt. Display 350 may present an electronic shopping cart to a consumer, as well as a representation of an item associated with the electronic shopping cart, wherein the representation is a first representation if the item does not possess a particular characteristic, and wherein the representation is a second representation if the item possesses the particular characteristic. Input device 340, display 350 and printer 360 may also be used in conjunction with functionality provided by consumer device 300 that is unrelated to the present invention.

Data storage device 390 stores Web browser 392, which is executed by microprocessor 310 and operated by a consumer to access, browse and download information such as Web pages from Web servers supporting HTTP communication. As described herein, such Web pages may comprise an online store. Web browser 392 may also be used to transmit information to Web servers.

Data storage device 390 also stores cookies 394. As is known to those skilled in the art of Web browsers, a cookie is stored on a device by a Web server during a session between the device and the Web server in order to provide identification and other information to the Web server during subsequent sessions with the device. In this regard, a cookie might specify a name of a consumer operating the device, preferences of the consumer, demographic information relating to the consumer, a consumer profile, a list of items purchased by the consumer, etc. Cookies stored among cookies 394 may be used in accordance with the present invention to determine a type of representation of an item to present to a consumer in order to indicate that the item possesses or does not possess a particular characteristic. Such a determination will be described below.

Data storage device 390 may also store application files, data files and system files other than those shown in FIG. 4. These files may be used by consumer device 300 to provide various functionalities to a consumer in addition to those provided by the present invention.

Item Database

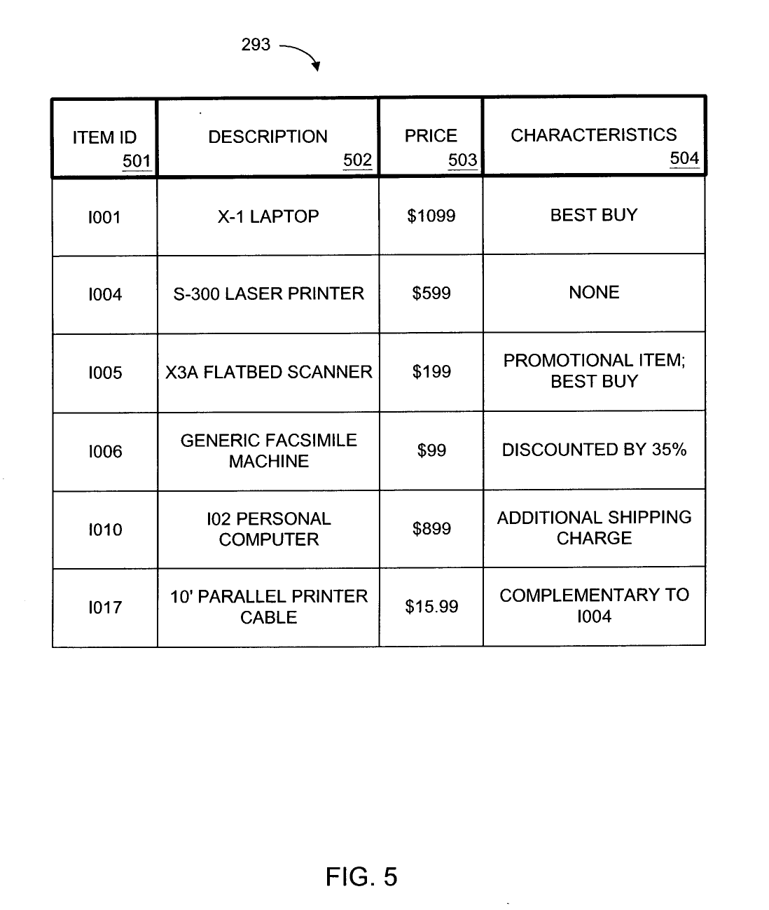

A tabular representation of a portion of item database 293 is shown in FIG. 5. The information stored in item database 293 may be entered by an operator of store server 200 through input device 240 or may be received from another device such as association server 400 over communication network 100. The stored information provides details regarding items offered for sale by an online store according to the present invention.

Item database 293 includes several records and associated fields. The fields include item ID field 501, description field 502, price field 503, and characteristics field 504. Item ID field 501 of a record represents an item associated with the record that is offered for sale by store server 200, and provides a shorthand notation for referring to the item. Description field 502 provides a description of an item that may be presented to a consumer along with an electronic shopping cart so that the consumer may identify the items associated with his shopping cart, and price field 503 specifies a price of an associated item.

Characteristics field 504 of a record identifies one or more characteristics of an item associated with the record. In a case that an item is associated with an electronic shopping cart, the item may be represented in the shopping cart by a representation indicating that the item possesses a characteristic from associated characteristic field 504. As shown in FIG. 5, such characteristics may include a rating, a discount amount, a promotional status, special shipping instructions, and complementary items. Of course, any characteristic may be specified in field 504, including, but not limited to: selected for purchase; tax-free; out of stock; luxury item; necessity; selected for immediate purchase; selected for later purchase; environmentally safe; environmentally hazardous; organically grown; selected for possible purchase; selected for purchase by particular date; promotional item selected by store; promotional item selected by manufacturer; associated with the shopping cart for a particular length of time; removed from shopping cart; complementary to other items associated with the shopping cart; discounted by a particular amount; associated with coupons; an item type; an item category; an availability; an expiration date; and a review.

The information stored in field 504 may be provided from association server 400, from manufacturers, from market research companies, or from other entities. Of course, item database 293 may include information in addition to or instead of that shown in FIG. 5. For example, item database 293 may include warranty information, manufacturer information, or the like. Moreover, an item represented in item database may comprise any type of good and/or service, including merchandise, stocks, bonds, promises, and knowledge.

Characteristics Database

Characteristics database 294 of FIG. 6 includes information relating to consumers. Each record of database 294 is associated with a characteristic described in characteristic field 601. Representation field 602 includes information usable to generate a representation indicating that an item possesses or does not possess an associated characteristic. The information may therefore include data such as one or more of: a data file containing representation, an executable file for generating a representation, and a name of and/or path to such a data file or executable file.

For example, a file named in representation field 602 may include processor-executable process steps to animate an icon representing an item in a particular way. The particular animation is intended to indicate that the item possesses a particular characteristic associated with the filename in field 602. Accordingly, the icon would not be thusly animated if the item did not possess the particular characteristic. In another example, the named file may be an image that is displayed in conjunction with a picture of an item to indicate that the item possesses a particular characteristic. Again, the representation would not include the image if the item did not possess the characteristic. It should be noted that a file named in representation field 602 may be used to generate a representation indicating that an item does not possess the associated characteristic. It should also be noted that a representation according to the invention includes visual representations such as a description, a photo, a drawing, an icon, an animation and a 3D image, as well as auditory, olfactory and tactile representations.

A representation that indicates that an item does not possess a particular characteristic may differ from a representation indicating that the item possesses the particular characteristic in many ways. As described above, one of the representations may simply comprise an icon while the other includes an animated version of the icon or an image placed over or near the icon. Also, the representations may differ in at least one of transparency, translucency, intensity, color and size.

It is contemplated that each of item database 293 and characteristics database 294 may include many more records than those shown and that each record may include associated fields other than those illustrated. It should also be noted that the tabular illustrations and accompanying descriptions of the databases merely represent relationships between stored information. A number of other arrangements may be employed besides those suggested.

### SPECIFIC EXAMPLE

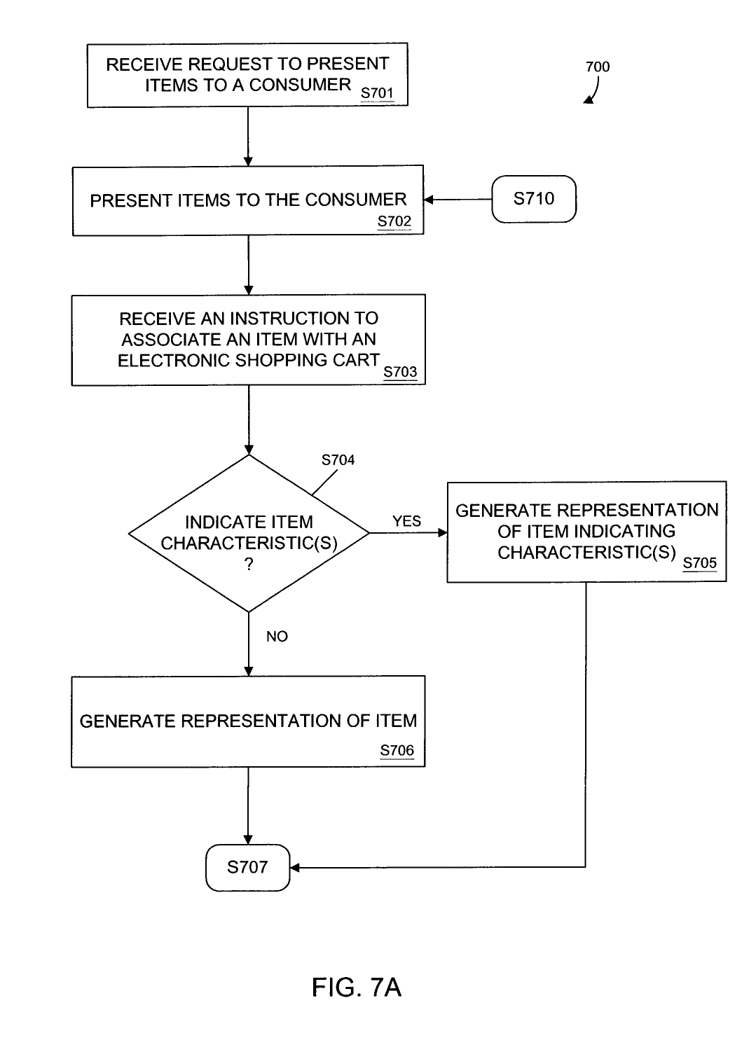

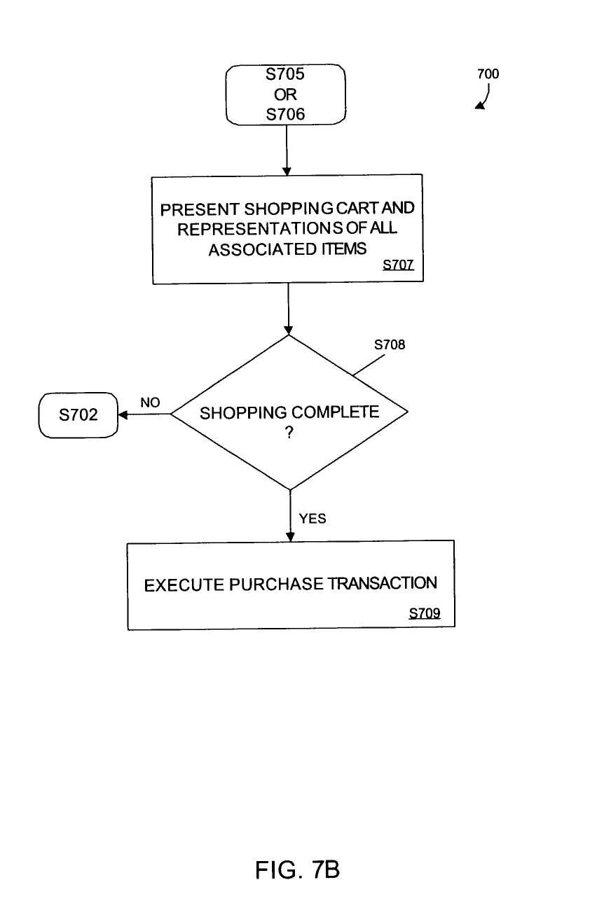

Process steps 700 of FIGS. 7A and 7B set forth an electronic shopping process according to some embodiments of the present invention. Process steps 700 are described below as if included in online store program 291 and executed by microprocessor 210 of store server 200. Of course, it should be noted that process steps 700 may be performed by any device or by any number of devices in combination, including consumer device 300 and control device 400. Moreover, some or all of process steps 700 may be performed manually.

Process steps 700 begin at step S701, in which a request is received to present items to a consumer. In some embodiments, the request is transmitted by Web browser 392 executing in consumer device 300. More specifically, a consumer uses input device 340 to input a Uniform Resource Locator (URL) into a window displayed on display 350 by Web browser 392. In response, an IP address corresponding to the URL is retrieved from a Domain Name Server and a request is sent via HTTP to the IP address. According to this example, the IP address corresponds to store server 200, therefore the request is received in step S701 by store server 200.

In an online store embodiment, the request may be received in step S701 while a consumer operates Web browser 394 to browse Web pages of the online store. Accordingly, the request may request access of a specific Web page of the online store. For example, the request may comprise a selection of a hyperlink to a Web page presenting computing-related items.

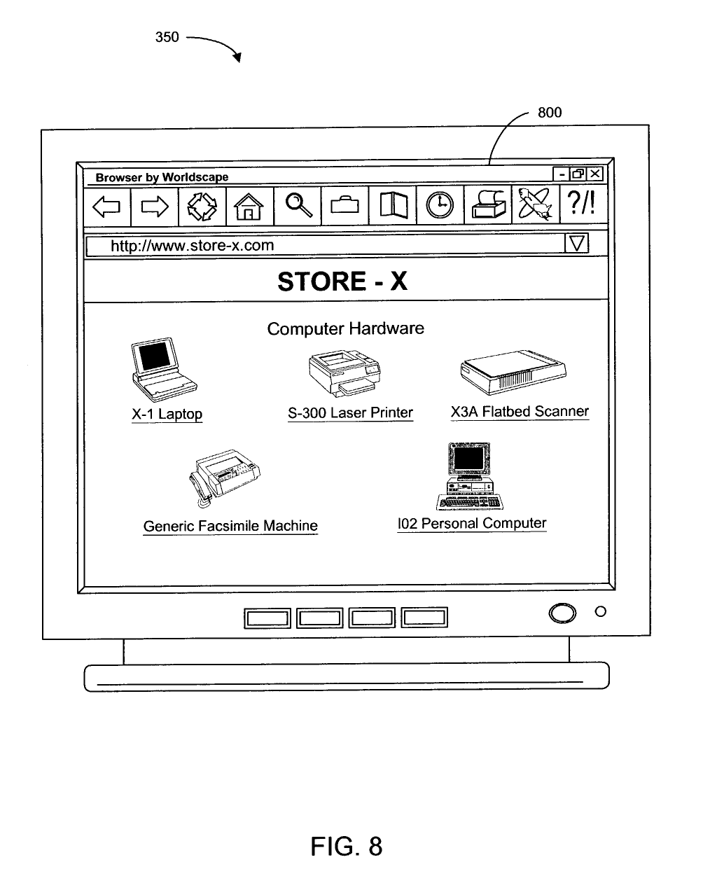

In response to the request, items are presented to the consumer in step S702. In a particular example of step S702, Web server 292 of server 200 creates an HTML page presenting the items in conjunction with online store program 291 and transmits the page to consumer device 300. FIG. 8 is a representative view of display 350 presenting such a page. As shown, page 800 presents images of several items along with explanatory text.

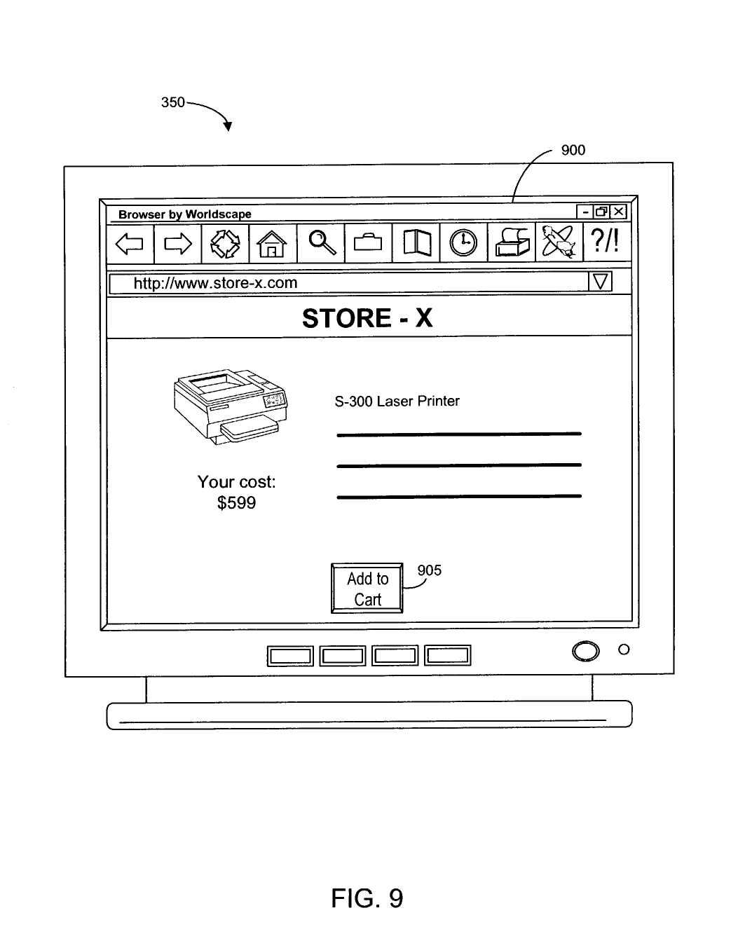

The consumer may select one of the presented items using input device 340, in response to which store server 200 creates and transmits an item detail page to consumer device 300. Item detail page 900 of FIG. 9 is an example of an item detail page presented to the consumer upon selection of the “S-300 Laser Printer” from page 900. In this embodiment, item detail page 900 presents an image of the selected item and text in addition to the explanatory text displayed in page 800. The image and the text may be retrieved from a record of item database 293 associated with the selected item.

Also included in item detail page 900 is “Add to Cart” icon 905. According to this example, “Add to Cart” icon 905 is selected by the consumer to issue an instruction to associate the selected item with an electronic shopping cart associated with the consumer. The instruction is received in step S703. In response, store server 200 executes steps to generate a representation of an electronic shopping cart that includes a representation of the item.

Specifically, in step S704, it is determined whether the representation should indicate that the item possesses or does not possess any characteristics. The determination may proceed in many ways. In some embodiments of step S704, item database 293 is analyzed to determine if the selected item is associated with any characteristics therein. According to the present example, no characteristics are associated with the selected item in item database 293. Flow therefore proceeds to step S706 because the determination in step S704 is negative. A representation of the item is generated in step S706. The representation may be generated by retrieving an image file or an executable file from sources such as data storage device 290 or association server 400. Flow proceeds from step S706 to step S707.

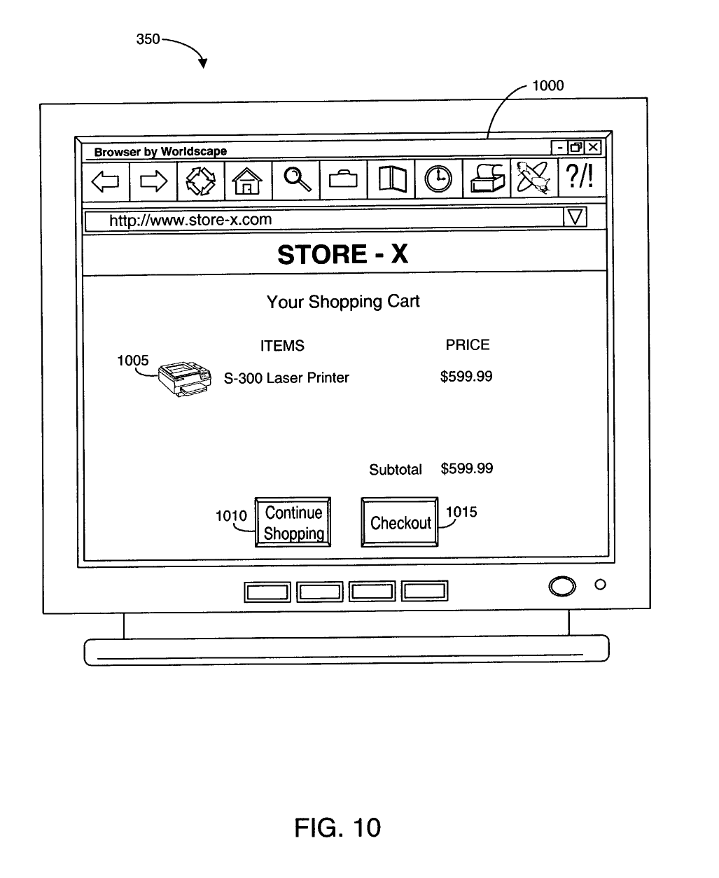

The electronic shopping cart is presented in step S707. Also presented in step S707 are representations of all items associated with the shopping cart. At least one of the presented representations is a first representation if the associated item does not possess a particular characteristic and is a second representation if the item possesses the particular characteristic. FIG. 10 shows display 350 presenting Web page 1000 and item representation 1005. As described above, item representation 1005 would appear differently if it was determined in step S704 to indicate that the item possesses a particular characteristic. Specifically, in such a case, item representation 1005 would indicate that the item possesses the particular characteristic.

Next, in step S708, flow returns to step S702 if the consumer selects “Continue Shopping” icon 1010 of Web page 1000. Alternatively, flow proceeds to step S709 if the consumer selects “Checkout” icon 1015. For purposes of the present example, it is assumed that the consumer selects icon 1010 of Web page 1000. Flow therefore returns to step S702 where, as described above, items are presented to the consumer.

It is now assumed that the consumer browses Web pages provided by store server 200 in step S702 to locate another item. Once the item is located, the consumer issues an instruction to associate the item with his shopping cart. The instruction is received in step S703. For the present example, the selected item is a 10′ parallel printer cable, identified in item database 293 by item ID “I017”.

Next, it is determined in step S704 to generate a representation of the selected item indicating that the item possesses a particular characteristic. This determination is based on the indication in characteristics field 504 that the item is “complementary to I004”. In this regard item “I004” is currently associated with the electronic shopping cart.

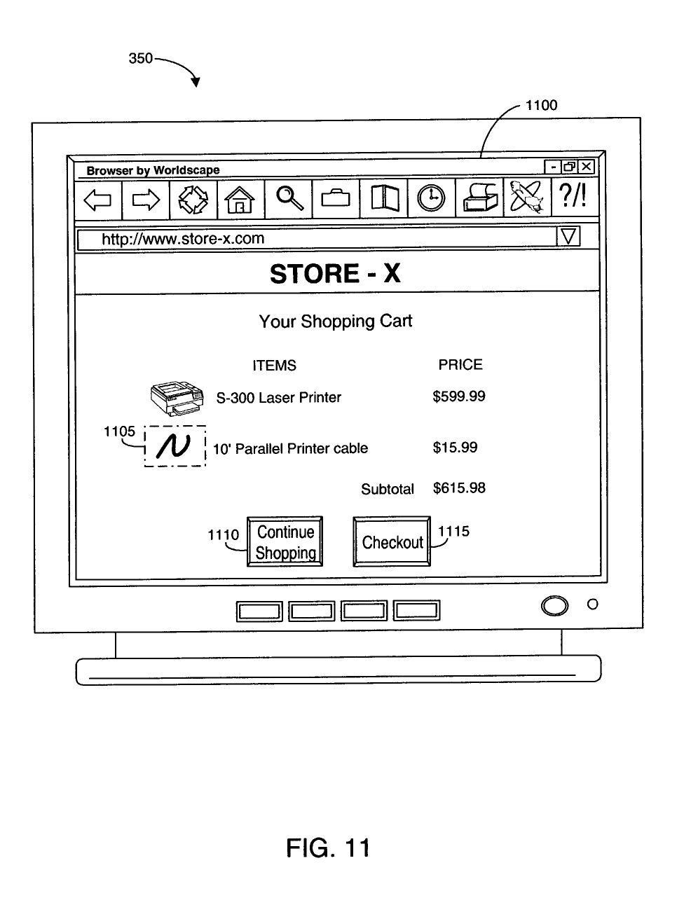

Accordingly, flow continues to step S705 to generate a representation of the item indicating possession of the characteristic. In order to generate the representation, the characteristic is identified in characteristics database 294 and a file named in associated representation field 602 is retrieved. “Border.dll” is retrieved in the case of the present example. The file is used to generate a representation indicating that the item possesses the characteristic. The representation is presented to the consumer in step S707, as shown in FIG. 11.

A representation may indicate that an item possesses a characteristic in many ways. As shown in FIG. 11, representation 1105 uses a dashed border to indicate that the represented item is complementary to another item associated with the shopping cart. The dashed border may indicate the possession of any other characteristic, including those listed above. Moreover, the dashed border may be used to indicate that an item does not possess a particular characteristic. Any other type of representation or modification to a representation, including those mentioned with respect to characteristics database 294, may be used instead of the dashed border. Generally, embodiments of the invention provide different representations of an item depending on whether or not the item possesses a particular characteristic.

Returning to process steps 700, it is determined in step S708 that the consumer has selected “Checkout” icon 1115. Accordingly, a purchase transaction is executed in step S709 to sell to the consumer each item associated with the electronic shopping cart.

Of course, embodiments of the invention may operate differently than the foregoing specific example. For example, store server 200 may provide an online store enabling a consumer to associate an item with an electronic shopping cart simply by dragging and dropping, cutting and pasting, or copying and pasting a presented representation of the item into a representation of the electronic shopping cart. Moreover, the presentation of the shopping cart may be based on style sheets, views and/or preferences specified by the consumer. In some embodiments, presentation of the shopping cart further includes presentation of advertising to the consumer based on items associated with the shopping cart.

In some embodiments, a consumer may choose to disassociate an item from an electronic shopping cart. The disassociated item may be represented by a representation that is presented along with the shopping cart. According to the present invention, the representation may be different from a representation of the item that was presented when the item was associated with the shopping cart. In one particular example, the representation indicating that the item was disassociated is a “grayed-out” version of the representation that indicated that the item was associated with the cart. Furthermore, in a case that the item is again selected to be associated with the shopping cart, the presented representation may revert to the non-“grayed-out” representation.

The above description sets forth several characteristics that may be indicated by representations according to the invention. Of course, many other characteristics may be indicated. For example, U.S. Patent Application Serial No. ______ (Atty. Docket No. I01.045 and Client Docket No. YOR920010378) relates to systems to associate items with an electronic shopping cart in response to consumer selection of an activity. Accordingly, an item may be represented by a first representation if it was associated with the electronic shopping cart in response to consumer selection of an activity, and represented by a second representation if it was not.

U.S. Patent Application Serial No. ______ (Atty. Docket No. I01.046 and Client Docket No. YOR920010377) relates to a system in which an item is associated with an electronic shopping cart by an optimization process. In addition, U.S. Patent Application Serial No. _____ (Atty. Docket No. I01.047 and Client Docket No. YOR920010372) describes systems in which a consumer selects an item to associate with an electronic shopping cart. The item is either associated with the shopping cart after approval is received from a third party or is temporarily associated with the shopping cart pending approval. Therefore, representations of items according to the present invention may indicate that an item was or was not associated with a cart by an optimization process, associated with a cart after approval by a third party, or temporarily associated with a cart pending third party approval.

U.S. Patent Application Serial No. ______ (Atty. Docket No. I01.075 and Client Docket No. YOR920010296) concern systems in which items may be associated with a shopping cart by entities other that a consumer associated with the shopping cart. Accordingly, the present invention may also be used in conjunction with these systems to present representations indicating that an item was or was not associated with a shopping cart by an entity other that a consumer associated with the shopping cart. Moreover, U.S. Patent Application Serial No. ______ (Atty. Docket No. I01.076 and Client Docket No. YOR920010297) relates to systems to associate items with different categories, or segments, within an electronic shopping. The present invention may therefore also be used to present representations indicating that an item is or is not a member of a particular segment.

Although the present invention has been described with respect to particular embodiments thereof, those skilled in the art will note that various substitutions may be made to those embodiments described herein without departing from the spirit and scope of the present invention.

What is claimed is:

1. A method for providing an electronic shopping cart, comprising;
presenting an electronic shopping cart to a consumer; and
presenting a representation of an item associated with the electronic shopping cart,
wherein the representation is a first representation if the item does not possess a particular characteristic, and
wherein the representation is a second representation if the item possesses the particular characteristic.

2. A method according to claim 1, wherein the representation is visual.

3. A method according to claim 2, wherein the representation comprises at least one of: a photo; a drawing; an icon; an animation; and a 3D image.

4. A method according to claim 2, wherein one of the first representation or the second representation is blinking.

5. A method according to claim 1, wherein the representation is auditory.

6. A method according to claim 1, wherein the representation is olfactory.

7. A method according to claim 1, wherein the representation is tactile.

8. A method according to claim 1, further comprising:
receiving an instruction from the consumer to disassociate the item from the electronic shopping cart;
removing the second representation from the electronic shopping cart; and presenting the first representation.

9. A method according to claim 1, further comprising:
receiving an instruction from the consumer to associate the item with the electronic shopping cart;
removing the first representation from the electronic shopping cart; and
presenting the second representation.

10. A method according to claim 1, wherein the first representation differs from the second representation in one or more of transparency, translucency, and intensity.

11. A method according to claim 1, wherein the first representation differs from the second representation in animation.

12. A method according to claim 1, wherein the first representation differs from the second representation in color.

13. A method according to claim 1, wherein the first representation differs from the second representation in size.

14. A method according to claim 13, wherein the first representation appears to be a larger or smaller version of the second representation.

15. A method according to claim 1, wherein the particular characteristic comprises at least one of: selected for purchase; tax-free; out of stock; luxury item; necessity; selected for immediate purchase; selected for later purchase; environmentally safe; environmentally hazardous; organically grown; selected for possible purchase; selected for purchase by particular date; promotional item selected by store; promotional item selected by manufacturer; associated with the shopping cart for a particular length of time; special shipping requirements; removed from shopping cart; complementary to other items associated with the shopping cart; discounted by a particular amount; associated with coupons; an item type; an item category; an availability; an expiration date; a rating; and a review.

16. A method according to claim 1, further comprising:
presenting representations of a plurality of items; and
enabling a consumer to drag-and-drop a presented representation into the electronic shopping cart so as to associate the presented representation with the electronic shopping cart.

17. A method according to claim 1, further comprising:
presenting representations of a plurality of items; and
enabling a consumer to cut-and-paste a presented representation into the electronic shopping cart so as to associate the presented representation with the electronic shopping cart.

18. A method according to claim 1, further comprising:
presenting representations of a plurality of items; and
enabling a consumer to copy-and-paste a presented representation into the electronic shopping cart so as to associate the presented representation with the electronic shopping cart.

19. A method according to claim 1, wherein the shopping cart is presented based on style sheets or views specified by the consumer.

20. A method according to claim 1, wherein the representation is presented based on preferences specified by the consumer.

21. A method according to claim 1, further comprising:
presenting advertising to the consumer based on items associated with the electronic shopping cart.

22. A method according to claim 1, wherein the characteristic comprises association with the electronic shopping cart in response to consumer selection of an activity.

23. A method according to claim 1, wherein the characteristic comprises approved for association with the electronic shopping cart.

24. A method according to claim 1, wherein the characteristic comprises associated with the shopping cart by an optimization process.

25. A method according to claim 1, wherein the characteristic comprises automatically associated with the shopping cart.

26. A method according to claim 1, wherein the characteristic comprises associated with the shopping cart in response to consumer selection of an activity.

27. A method according to claim 1, wherein the characteristic comprises membership in a particular segment.

28. A medium storing processor-executable process steps to provide an electronic shopping cart, the process steps comprising:
a step to present an electronic shopping cart to a consumer; and
a step to present a representation of an item associated with the electronic shopping cart,
wherein the representation is a first representation if the item does not possess a particular characteristic, and
wherein the representation is a second representation if the item possesses the particular characteristic.

29. A medium according to claim 28, the process steps further comprising:
a step to receive an instruction from the consumer to disassociate the item from the electronic shopping cart;
a step to remove the second representation from the electronic shopping cart; and
a step to present the first representation.

30. A medium according to claim 28, the process steps further comprising:
a step to receive an instruction from the consumer to associate the item with the electronic shopping cart;
a step to remove the first representation from the electronic shopping cart; and
a step to present the second representation.

31. A medium according to claim 28, wherein the first representation differs from the second representation in one or more of transparency, translucency, and intensity.

32. A medium according to claim 28, wherein the first representation differs from the second representation in animation.

33. A medium according to claim 28, wherein the first representation differs from the second representation in color.

34. A medium according to claim 28, wherein the first representation differs from the second representation in size.

35. A medium according to claim 34, wherein the first representation appears to be a larger or smaller version of the second representation.

36. A medium according to claim 28, wherein the particular characteristic comprises at least one of: selected for purchase; tax-free; out of stock; luxury item; necessity; selected for immediate purchase; selected for later purchase; environmentally safe; environmentally hazardous; organically grown; selected for possible purchase; selected for purchase by particular date; promotional item selected by store; promotional item selected by manufacturer; associated with the shopping cart for a particular length of time; special shipping requirements; removed from shopping cart; complementary to other items associated with the shopping cart; discounted by a particular amount; associated with coupons; an item type; an item category; an availability; an expiration date; a rating; and a review.

37. A medium according to claim 28, wherein the characteristic comprises association with the electronic shopping cart in response to consumer selection of an activity.

38. A medium according to claim 28, wherein the characteristic comprises approved for association with the electronic shopping cart.

39. A medium according to claim 28, wherein the characteristic comprises associated with the shopping cart by an optimization process.

40. A medium according to claim 28, wherein the characteristic comprises automatically associated with the shopping cart.

41. A medium according to claim 28, wherein the characteristic comprises associated with the shopping cart in response to consumer selection of an activity.

42. A medium according to claim 28, wherein the characteristic comprises membership in a particular segment.

43. An apparatus to provide an electronic shopping cart, comprising:
a processor; and
a storage device in communication with the processor and storing instructions adapted to be executed by the processor to:
present an electronic shopping cart to a consumer; and
present a representation of an item associated with the electronic shopping cart,
wherein the representation is a first representation if the item does not possess a particular characteristic, and
wherein the representation is a second representation if the item possesses the particular characteristic

44. An apparatus according to claim 43, further comprising:
receiving an instruction from the consumer to disassociate the item from the electronic shopping cart;
removing the second representation from the electronic shopping cart; and
presenting the first representation.

45. An apparatus according to claim 43, further comprising:
receiving an instruction from the consumer to associate the item with the electronic shopping cart;
removing the first representation from the electronic shopping cart; and
presenting the second representation.

46. An apparatus according to claim 43, wherein the first representation differs from the second representation in one or more of transparency, translucency, and intensity.

47. An apparatus according to claim 43, wherein the first representation differs from the second representation in animation.

48. An apparatus according to claim 43, wherein the first representation differs from the second representation in color.

49. An apparatus according to claim 43, wherein the first representation differs from the second representation in size.

50. An apparatus according to claim 49, wherein the first representation appears to be a larger or smaller version of the second representation.

51. An apparatus according to claim 43, wherein the particular characteristic comprises at least one of: selected for purchase; tax-free; out of stock; luxury item; necessity; selected for immediate purchase; selected for later purchase; environmentally safe; environmentally hazardous; organically grown; selected for possible purchase; selected for purchase by particular date; promotional item selected by store; promotional item selected by manufacturer; associated with the shopping cart for a particular length of time; special shipping requirements; removed from shopping cart; complementary to other items associated with the shopping cart; discounted by a particular amount; associated with coupons; an item type; an item category; an availability; an expiration date; a rating; and a review.

52. An apparatus according to claim 43, wherein the characteristic comprises association with the electronic shopping cart in response to consumer selection of an activity.

53. An apparatus according to claim 43, wherein the characteristic comprises approved for association with the electronic shopping cart.

54. An apparatus according to claim 43, wherein the characteristic comprises associated with the shopping cart by an optimization process.

55. An apparatus according to claim 43, wherein the characteristic comprises automatically associated with the shopping cart.

56. An apparatus according to claim 43, wherein the characteristic comprises associated with the shopping cart in response to consumer selection of an activity.

57. An apparatus according to claim 43, wherein the characteristic comprises membership in a particular segment.
